(19) United States
(12) Patent Application Publication
(10) Pub. No.: US 2025/0101967 A1
(43) Pub. Date: Mar. 27, 2025

(54) SYSTEM FOR DETECTING ABNORMALITY IN HYDRAULIC ROTATING EQUIPMENT

(71) Applicant: KAWASAKI JUKOGYO KABUSHIKI KAISHA, Kobe-shi (JP)

(72) Inventors: Akihiro KONDO, Kobe-shi (JP); Kazuya NAGAMUNE, Kobe-shi (JP); Yousuke KATAOKA, Kobe-shi (JP)

(73) Assignee: KAWASAKI JUKOGYO KABUSHIKI KAISHA, Kobe-shi (JP)

(21) Appl. No.: 18/888,291

(22) Filed: Sep. 18, 2024

(30) Foreign Application Priority Data
Sep. 21, 2023 (JP) 2023-155471

(51) Int. Cl. F04B 1/30; F04B 1/124; F04B 1/128

(52) U.S. Cl. CPC F04B 1/30; F04B 1/124; F04B 1/128

(57) ABSTRACT

A system for detecting an abnormality in hydraulic rotating equipment according to one embodiment includes: a sensor that measures a drain pressure of the hydraulic rotating equipment; and processing circuitry. The hydraulic rotating equipment is of an axial piston type and includes M pistons. The processing circuitry performs frequency analysis on a pressure waveform that is a result of measurement by the sensor to generate a frequency spectrum, and if a pressure amplitude of a rotational Mth-degree component in the frequency spectrum is less than a predetermined percentage of a pressure amplitude of a rotational first-degree component in the frequency spectrum, determines that the hydraulic rotating equipment is in a normal condition, whereas if the pressure amplitude of the rotational Mth-degree component is greater than the predetermined percentage of the pressure amplitude of the rotational first-degree component, determines that there is an abnormality in the hydraulic rotating equipment.

### CROSS-REFERENCE TO RELATED APPLICATION

This application claims priority to and the benefit of Japanese Patent Application No. 2023-155471, filed on Sep. 21, 2023, the entire disclosure of which is incorporated herein by reference.

### BACKGROUND OF THE INVENTION

### Field of the Invention

The present disclosure relates to a system for detecting an abnormality in hydraulic rotating equipment.

### Description of the Related Art

Conventionally, various methods have been adopted for abnormality detection in hydraulic rotating equipment of an axial piston type. For example, Japanese Laid-Open Patent Application Publication No. 2013-170509 discloses an abnormality detector to detect an abnormality in an axial piston pump by using a delivery pressure or drain pressure of the axial piston pump.

Specifically, the abnormality detector of Japanese Laid-Open Patent Application Publication No. 2013-170509 measures the delivery pressure or drain pressure of the axial piston pump by a sensor, performs frequency analysis on a pressure waveform that is a result of the measurement by the sensor to generate a frequency spectrum, and determines whether or not there is an abnormality by comparing the pressure amplitude of a rotational frequency in the frequency spectrum with a threshold. The rotational frequency is N/60 [Hz] in a case where the rotation speed of the pump is N [rpm].

### SUMMARY OF THE INVENTION

However, it is difficult for the abnormality detector of Japanese Laid-Open Patent Application Publication No. 2013-170509 to set a suitable threshold for accurately detecting an abnormality in the hydraulic rotating equipment, which is an axial piston pump.

In view of the above, an object of the present disclosure is to provide a system for detecting an abnormality in hydraulic rotating equipment, the system being capable of accurately detecting an abnormality in the hydraulic rotating equipment without use of a threshold.

A first aspect of the present disclosure provides a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a pressure amplitude of a rotational Mth-degree component in the frequency spectrum, the rotational Mth-degree component being M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the pressure amplitude of the rotational Mth-degree component is greater than the predetermined percentage of the pressure amplitude of the rotational first-degree component, determines that there is an abnormality in the hydraulic rotating equipment.

A second aspect of the present disclosure provides a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a sum of pressure amplitudes of respective at least two rotational degree components selected from among rotational second-degree to Mth-degree components in the frequency spectrum, the rotational second-degree to Mth-degree components being two times to M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

A third aspect of the present disclosure provides a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a sum of pressure amplitudes of respective at least two rotational degree components selected from among rotational Mth-degree to (2M)th-degree components in the frequency spectrum, the rotational Mth-degree to (2M)th-degree components being M times to (2M) times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

The present disclosure provides a system for detecting an abnormality in hydraulic rotating equipment, the system being capable of accurately detecting an abnormality in hydraulic rotating equipment without use of a threshold.

### BRIEF DESCRIPTION OF THE DRAWINGS

FIG. 1 shows a hydraulic circuit including an axial piston pump as hydraulic rotating equipment, and shows an abnormality detection system according to one embodiment.

FIG. 2 is a sectional view of the axial piston pump.

FIG. 3 is a graph showing a frequency spectrum that is generated by performing frequency analysis on a pressure waveform.

### DETAILED DESCRIPTION

### Embodiment 1

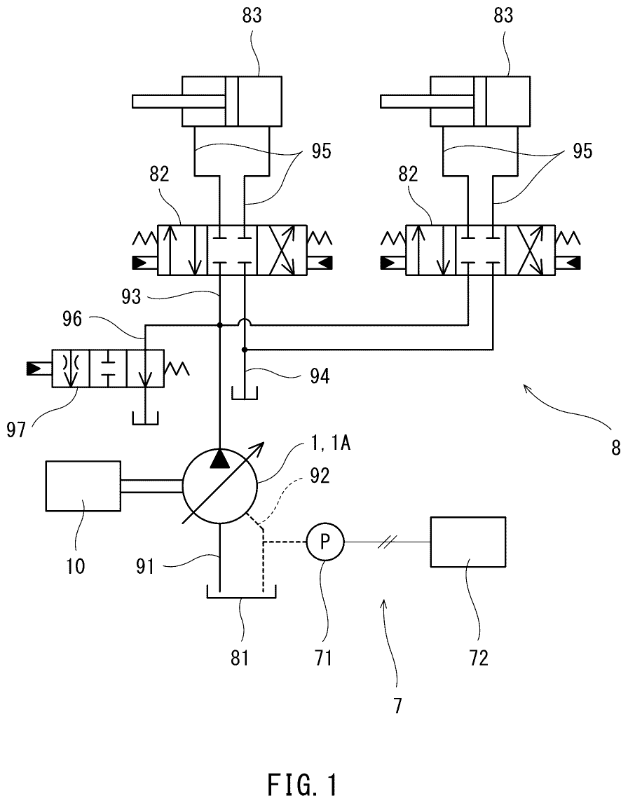

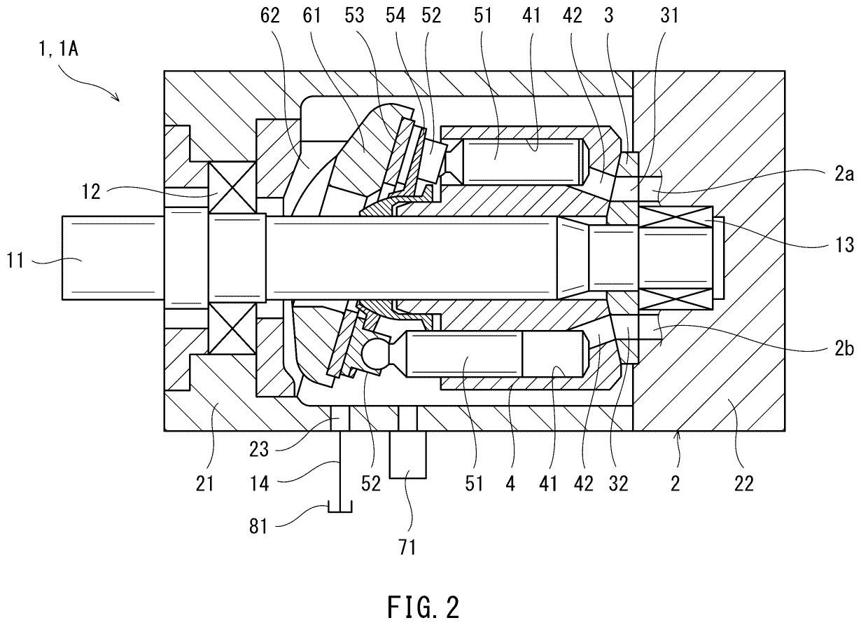

FIG. 1 shows an abnormality detection system 7 for detecting an abnormality in hydraulic rotating equipment 1 according to one embodiment. As shown in FIG. 2, the hydraulic rotating equipment 1 is of an axial piston type, and includes M pistons 51. In the present embodiment, the hydraulic rotating equipment 1 is an axial piston pump 1A. Alternatively, the hydraulic rotating equipment 1 may be an axial piston motor.

As shown in FIG. 1, in the present embodiment, the axial piston pump 1A forms a hydraulic circuit 8 of a construction machine together with a tank 81 and hydraulic actuators 83. In FIG. 1, the number of hydraulic actuators 83 is two. Alternatively, the number of hydraulic actuators 83 may be three or more. Typically, a hydraulic liquid used in the hydraulic circuit 8 is oil. For example, the construction machine is a hydraulic excavator.

Further, in the present embodiment, the axial piston pump 1A is driven by an engine 10 with L cylinders (L is an even number). Alternatively, the axial piston pump 1A may be driven by an electric motor.

Still further, in the present embodiment, the axial piston pump 1A is a variable displacement pump. Alternatively, in a case where the axial piston pump 1A is driven by an electric motor, or depending on the hydraulic circuit 8, the axial piston pump 1A may be a fixed displacement pump.

The hydraulic circuit 8 includes control valves 82, each of which is located between the axial piston pump 1A and a corresponding one of the hydraulic actuators 83. Each control valve 82 is connected to the corresponding hydraulic actuator 83 by a pair of supply/discharge lines 95. Each hydraulic actuator 83 may be a hydraulic cylinder, or may be a hydraulic motor.

The axial piston pump 1A is connected to the tank 81 by a suction line 91, and also connected to all the control valves 82 by a delivery line 93. All the control valves 82 are connected to the tank 81 by a tank line 94. The axial piston pump 1A is connected to the tank 81 also by a drain line 92.

The abnormality detection system 7 includes: a sensor 71, which measures a drain pressure of the axial piston pump 1A; and processing circuitry 72 electrically connected to the sensor 71.

An unloading line 96 is branched off from the delivery line 93, and the unloading line 96 connects to the tank 81. An unloading valve 97 is located on the unloading line 96.

In the present embodiment, the unloading valve 97 is a spool valve whose spool shifts in accordance with a pilot pressure. The unloading valve 97 receives the pilot pressure from a solenoid proportional valve. The solenoid proportional valve outputs a secondary pressure as the pilot pressure. The unloading valve 97 is controlled by the processing circuitry 72 of the abnormality detection system 7 via the solenoid proportional valve. Alternatively, the unloading valve 97 may be a solenoid valve whose spool shifts in accordance with an electrical signal.

In the present embodiment, when the spool of the unloading valve 97 is in a neutral position, the opening degree of the unloading valve 97 is 100%. When the spool shifts from the neutral position to a predetermined position, the opening degree of the unloading valve 97 becomes 0%. When the spool further shifts from the predetermined position, the opening degree of the unloading valve 97 becomes a predetermined percentage. In other words, between a fully open position of the unloading valve 97, in which the unloading valve 97 is in a neutral state, and a fully closed position of the unloading valve 97, the opening degree of the unloading valve 97 is arbitrarily changeable, and also, the position of the unloading valve 97 is changeable to an abnormality detection position in which the opening degree is the aforementioned predetermined percentage. The predetermined percentage is, for example, 5% or more and 65% or less. The abnormality detection position is a position to obtain a below-described pressure waveform.

Alternatively, the abnormality detection position may be the position in which the unloading valve 97 is in the neutral state, and in accordance with shifting of the spool from the neutral position, the position of the unloading valve 97 may change from the abnormality detection position to the fully open position via the fully closed position. Further alternatively, the abnormality detection position of the unloading valve 97 need not be located outside the fully open position and the fully closed position, and a particular position between the fully open position and the fully closed position may be used as the abnormality detection position.

A shown in FIG. 2, in the present embodiment, the axial piston pump 1A is a swash plate pump. Alternatively, the axial piston pump 1A may be a bent axis pump.

Specifically, the axial piston pump 1A includes: a hollow casing 2; and a rotating shaft 11, which extends from the inside of the casing 2 to the outside thereof. The rotating shaft 11 is coupled to an output shaft of the engine 10. A valve plate 3, a cylinder block 4, a swash plate 61, and a support base 62 are located inside the casing 2.

Hereinafter, for the sake of convenience of the description, the axial direction of the rotating shaft 11 is referred to as the forward-backward direction (specifically, the direction toward one end of the rotating shaft 11, the one end being positioned outside the casing 2, is defined as forward, and the opposite direction toward the other end of the rotating shaft 11 is defined as backward), and two directions orthogonal to the axial direction of the rotating shaft 11 are referred to as the upward-downward direction (specifically, the direction toward the upper side of FIG. 2 is defined as upward, and the opposite direction toward the lower side of FIG. 2 is defined as downward) and the left-right direction.

The casing 2 includes: a container-shaped casing body 21, which is open backward; and a valve cover 22, which seals an opening of the casing body 21. The rotating shaft 11 penetrates a bottom portion of the casing body 21. A bearing 12 and a bearing 13, which support the rotating shaft 11 in a rotatable manner, are held by the bottom portion of the casing body 21 and the valve cover 22, respectively.

The valve plate 3 is mounted to a front surface of the valve cover 22. The valve plate 3 includes an arc-shaped first port 31 and an arc-shaped second port 32, which are reversed shapes from each other. In FIG. 2, the first port 31 is drawn on the upper top dead center, and the second port 32 is drawn on the lower bottom dead center. However, the actual positions of the first port 31 and the second port 32 are located on both sides of the rotating shaft 11 in the left-right direction. The left-right direction is orthogonal to the direction in which the top dead center and the bottom dead center are apart from each other. The top dead center is the point where a below-described piston 51 is at its backmost position, whereas the bottom dead center is the point where the piston 51 is at its frontmost position.

In the present embodiment, the rotating shaft 11 is rotated in one direction. Accordingly, the first port 31 is a suction port, and the second port 32 is a delivery port. That is, in the rotation direction of the rotating shaft 11, the first port 31, which is the suction port, is positioned downstream of the top dead center and upstream of the bottom dead center, whereas the second port 32, which is the delivery port, is positioned downstream of the bottom dead center and upstream of the top dead center.

However, depending on the hydraulic circuit 8, the rotating shaft 11 may be rotated bi-directionally. In this case, when the rotating shaft 11 is rotated in one direction, the first port 31 serves as the suction port and the second port 32 serves as the delivery port, whereas when the rotating shaft 11 is rotated in the opposite direction, the second port 32 serves as the suction port, and the first port 31 serves as the delivery port.

The valve cover 22 includes: a first passage 2a, which communicates with the first port 31; and a second passage 2b, which communicates with the second port 32. The first passage 2a and the second passage 2b are open in an outer peripheral surface or back surface of the valve cover 22, and these openings form external connection ports. As described above, in the present embodiment, the rotating shaft 11 is rotated in one direction. Accordingly, the first passage 2a serves as a suction passage, and the second passage 2b serves as a delivery passage.

The cylinder block 4 is fixed to the rotating shaft 11, and slides on the valve plate 3 by rotating together with the rotating shaft 11. The cylinder block 4 includes M cylinder bores 41, which are open forward around the rotating shaft 11. These M cylinder bores 41 receive the M pistons 51 therein, respectively. In the present embodiment, M=9.

The cylinder block 4 includes cylinder ports 42, which extend from the respective cylinder bores 41 to the valve plate 3. Some of the cylinder ports 42 communicate with the first port 31, and some of the other cylinder ports 42 communicate with the second port 32.

M shoes 52 are mounted to the heads of the respective pistons 51. In the present embodiment, the shoes 52 slide on the swash plate 61 via an annular shoe plate 53 mounted to the swash plate 61. Alternatively, the shoe plate 53 may be eliminated, and the shoes 52 may directly slide on the swash plate 61. The shoes 52 are held down by a holding plate 54, such that the shoes 52 are kept in contact with the shoe plate 53.

The swash plate 61 is supported by the support base 62 located on the bottom portion of the casing body 21, such that the swash plate 61 is swingable about a swing axis that extends in the left-right direction. Although not illustrated, the axial piston pump 1A includes a regulator that causes the swash plate 61 to swing.

The inside of the casing 2 is filled with a hydraulic liquid that leaks, for example, from between the valve plate 3 and the cylinder block 4 and from between each piston 51 and the inner peripheral surface of the corresponding cylinder bore 41. The casing body 21 includes a drain port 23. The drain port 23 is connected to the tank 81 by a drain pipe 14. That is, the inside of the casing 2 and the drain pipe 14 form the aforementioned drain line 92.

In the present embodiment, the sensor 71 of the abnormality detection system 7 is located on the casing body 21. Alternatively, the sensor 71 may be located on the drain pipe 14.

Regarding the processing circuitry 72, the functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The processing circuitry 72 determines whether or not there is an abnormality in the hydraulic rotating equipment 1, which is the axial piston pump 1A. In the present embodiment, the engine 10 transitions to idling operation when none of the hydraulic actuators 83 is in action. In the idling operation, the rotation speed of the engine 10 is kept low.

During the idling operation, the processing circuitry 72 switches the unloading valve 97 to the abnormality detection position. Accordingly, the delivery pressure of the axial piston pump 1A, which is the hydraulic rotating equipment 1, is kept to a predetermined value. For example, the predetermined value is 0.01 MPa or greater and 3 Pa or less. In this state, the sensor 71 measures the drain pressure of the axial piston pump 1A, and the processing circuitry 72 stores the measured drain pressure as a pressure waveform. That is, the stored pressure waveform is a result of the measurement by the sensor 71.

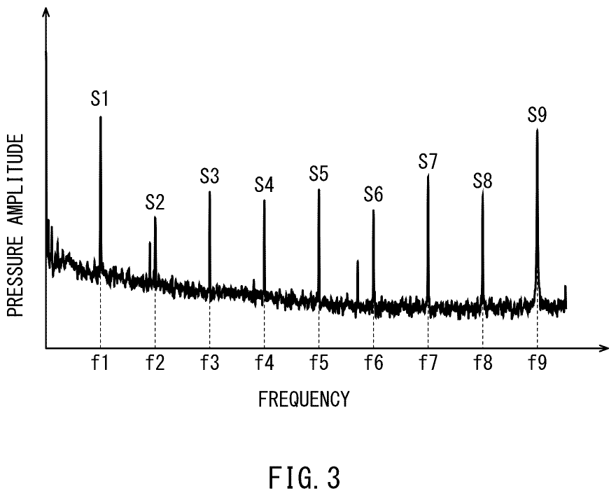

Then, the processing circuitry 72 performs frequency analysis on the stored pressure waveform to generate a frequency spectrum as shown in FIG. 3. Thereafter, the processing circuitry 72 compares a pressure amplitude S9 of a rotational ninth-degree component f9 in the frequency spectrum, the rotational ninth-degree component f9 being M times, i.e., nine times, as great as a rotational frequency, with a predetermined percentage R1 of a pressure amplitude S1 of a rotational first-degree component f1 in the frequency spectrum, the rotational first-degree component f1 being one time as great as the rotational frequency (R1=S9/S1). The rotational frequency is N/60 [Hz] in a case where the rotation speed of the hydraulic rotating equipment 1 is N [rpm]. The predetermined percentage R1 may be arbitrarily set within a range from 10% to 1000%. For example, the predetermined percentage R1 may be 100%, or may be 50%.

FIG. 3 shows the frequency spectrum when there is an abnormality in the hydraulic rotating equipment 1. The frequency spectrum when the hydraulic rotating equipment 1 is in a normal condition is such that the pressure amplitude S9 of the rotational ninth-degree component f9 is small, and the pressure amplitude S1 of the rotational first-degree component f1 is large. On the other hand, when there is an abnormality in the hydraulic rotating equipment 1, the pressure amplitude S9 of the rotational ninth-degree component f9 is relatively large in a manner similar to the pressure amplitude S1 of the rotational first-degree component f1.

If the pressure amplitude S9 of the rotational ninth-degree component f9 is less than the predetermined percentage R1 of the pressure amplitude S1 of the rotational first-degree component f1, i.e., S9<S1×R1/100, then the processing circuitry 72 determines that the hydraulic rotating equipment 1 is in a normal condition, whereas if the pressure amplitude S9 of the rotational ninth-degree component f9 is greater than the predetermined percentage R1 of the pressure amplitude S1 of the rotational first-degree component f1, i.e., S9>S1×R1/100, then the processing circuitry 72 determines that there is an abnormality in the hydraulic rotating equipment 1.

As described above, in the abnormality detection system 7 of the present embodiment, the pressure amplitude S9 of the rotational ninth-degree component f9, which is a rotational Mth-degree component, is compared with the predetermined percentage R1 of the pressure amplitude S1 of the rotational first-degree component f1, and thereby whether or not there is an abnormality in the hydraulic rotating equipment 1 is determined. In this manner, an abnormality in the hydraulic rotating equipment 1 can be detected without use of a threshold. In addition, with the above-described determination method, an abnormality in the hydraulic rotating equipment 1 can be detected accurately.

Moreover, in the present embodiment, the processing circuitry 72 performs frequency analysis on the pressure waveform measured during the idling operation. Accordingly, each time the idling operation is performed, the determination as to whether or not there is an abnormality can be performed automatically, and thus there is no loss of time. Furthermore, it is not necessary to require an operator of the construction machine to perform an onerous operation, such as pressing a drain pressure measurement start button.

### Embodiment 2

Next, the abnormality detection system according to Embodiment 2 is described. The present embodiment is different from Embodiment 1 only in the manner of determining whether or not there is an abnormality in the hydraulic rotating equipment 1 by the processing circuitry 72. The same is true for Embodiment 3, which will be described below. That is, the processing circuitry 72 determines whether or not there is an abnormality in the hydraulic rotating equipment 1 during idling operation of the engine 10.

In the present embodiment, the processing circuitry 72 compares a sum Z1 with a predetermined percentage R2 of the pressure amplitude S1 of the rotational first-degree component f1. The sum Z1 is the sum of pressure amplitudes of respective at least two rotational degree components selected from among the rotational second-degree to ninth-degree components f2 to f9 in the frequency spectrum, the rotational second-degree to ninth-degree components f2 to f9 being two times to M times, i.e., nine times, as great as the rotational frequency. The predetermined percentage R2 may be arbitrarily set within a range from 10% to 1000%. For example, the predetermined percentage R2 may be 100%, or may be 50%.

For example, in a case where the selected at least two rotational degree components are all of the rotational second-degree to ninth-degree components f2 to f9, the sum Z1 is expressed by an equation shown below. However, desirably, the selected at least two rotational degree components are the rotational second-degree component f2 and the rotational ninth-degree component f9.

$$Z 1 = {\sum }_{i = 2}^{9} Si \qquad [ Math . 1 ]$$

In a case where there is an abnormality in the hydraulic rotating equipment 1, not only the pressure amplitude S9 of the rotational ninth-degree component f9, but also the pressure amplitudes S2 to S8 of the rotational second-degree to eighth-degree components f2 to f8 are relatively large in a manner similar to the pressure amplitude S1 of the rotational first-degree component f1.

If the sum Z1 is less than the predetermined percentage R2 of the pressure amplitude S1 of the rotational first-degree component f1, i.e., Z1<S1×R2/100, then the processing circuitry 72 determines that the hydraulic rotating equipment 1 is in a normal condition, whereas if the sum Z1 is greater than the predetermined percentage R2 of the pressure amplitude S1 of the rotational first-degree component f1, i.e., Z1>S1×R2/100, then the processing circuitry 72 determines that there is an abnormality in the hydraulic rotating equipment 1.

In the present embodiment, the sum Z1 of the pressure amplitudes of the at least two rotational degree components selected from among the rotational second-degree component f2 to the rotational ninth-degree, i.e., Mth-degree, component f9 is compared with the predetermined percentage R2 of the pressure amplitude S1 of the rotational first-degree component f1, and thereby whether or not there is an abnormality in the hydraulic rotating equipment 1 is determined. In this manner, an abnormality in the hydraulic rotating equipment 1 can be detected without use of a threshold. In addition, with the above-described determination method, an abnormality in the hydraulic rotating equipment 1 can be detected accurately.

When determining the sum Z1, the processing circuitry 72 may multiply each of the pressure amplitudes of the selected at least two rotational degree components by a coefficient K. For example, in a case where the selected at least two rotational degree components are all of the rotational second-degree to ninth-degree components f2 to f9, the processing circuitry 72 may determine the sum Z1 based on an equation shown below. In this manner, detection accuracy can be improved by weighting using the coefficient K. In the equation below, a coefficient Ki may be set arbitrarily within a range from 0.001 to 10 for each i.

$$Z 1 = {\sum }_{i = 2}^{9} Ki \cdot Si \qquad [ Math . 2 ]$$

In a case where the number L of cylinders of the engine 10, which drives the axial piston pump 1A, is six, the selected at least two rotational degree components may exclude the rotational third-degree component f3, which is the rotational (L/2)th-degree component. In this case, when determining the sum Z1 of the pressure amplitudes of the rotational degree components, the pressure amplitude S3 of the rotational third-degree component f3, which is the rotational (L/2)th-degree component, is excluded. Accordingly, pulsation of the drain pressure due to the engine 10 can be ignored. At the pressure amplitude S6 of the rotational sixth-degree component f6, which is the rotational Lth-degree component, the influence of the pulsation due to the engine 10 is small. Therefore, the rotational sixth-degree component f6 may be included in the selected at least two rotational degree components.

Also in a case where the selected at least two rotational degree components exclude the rotational third-degree component f3, the processing circuitry 72 may multiply each of the pressure amplitudes of the selected at least two rotational degree components by the coefficient K.

### Embodiment 3

Next, the abnormality detection system according to Embodiment 3 is described. In the present embodiment, the processing circuitry 72 compares a sum Z2 with a predetermined percentage R3 of the pressure amplitude S1 of the rotational first-degree component f1. The sum Z2 is the sum of pressure amplitudes of respective at least two rotational degree components selected from among the rotational ninth-degree to eighteenth-degree components f9 to f18 in the frequency spectrum, the rotational ninth-degree to eighteenth-degree components f9 to f18 being M times, i.e., 9 times, to (2M) times, i.e., 18 times, as great as the rotational frequency. The predetermined percentage R3 may be arbitrarily set within a range from 10% to 1000%. For example, the predetermined percentage R3 may be 100%, or may be 50%.

For example, in a case where the selected at least two rotational degree components are all of the rotational ninth-degree to eighteenth-degree components f9 to f18, the sum Z2 is expressed by an equation shown below. However, desirably, the selected at least two rotational degree components are the rotational ninth-degree component f9 and the rotational eighteenth-degree component f18.

$$Z 2 = {\sum }_{i = 9}^{18} Si \qquad [ Math . 3 ]$$

In a case where there is an abnormality in the hydraulic rotating equipment 1, not only the pressure amplitude S9 of the rotational ninth-degree component f9, but also the pressure amplitudes S10 to S18 of the rotational tenth-degree to eighteenth-degree components f10 to f18 are relatively large in a manner similar to the pressure amplitude S1 of the rotational first-degree component f1.

If the sum Z2 is less than the predetermined percentage R3 of the pressure amplitude S1 of the rotational first-degree component f1, i.e., Z2<S1×R3/100, then the processing circuitry 72 determines that the hydraulic rotating equipment 1 is in a normal condition, whereas if the sum Z2 is greater than the predetermined percentage R3 of the pressure amplitude S1 of the rotational first-degree component f1, i.e., Z2>S1×R3/100, then the processing circuitry 72 determines that there is an abnormality in the hydraulic rotating equipment 1.

In the present embodiment, the sum Z2 of the pressure amplitudes of the at least two rotational degree components selected from among the rotational ninth-degree component f9, which is the rotational Mth-degree component, to the rotational eighteenth-degree component f18, which is the rotational (2M)th-degree component, is compared with the predetermined percentage R3 of the pressure amplitude S1 of the rotational first-degree component f1, and thereby whether or not there is an abnormality in the hydraulic rotating equipment 1 is determined. In this manner, an abnormality in the hydraulic rotating equipment 1 can be detected without use of a threshold. In addition, with the above-described determination method, an abnormality in the hydraulic rotating equipment 1 can be detected accurately.

When determining the sum Z2, the processing circuitry 72 may multiply each of the pressure amplitudes of the selected at least two rotational degree components by the coefficient K. For example, in a case where the selected at least two rotational degree components are all of the rotational ninth-degree to eighteenth-degree components f9 to f18, the processing circuitry 72 may determine the sum Z2 based on an equation shown below. In this manner, detection accuracy can be improved by weighting using the coefficient K. In the equation below, a coefficient Ki may be set arbitrarily within a range from 0.001 to 10 for each i.

$$Z 2 = {\sum }_{i = 9}^{18} Ki \cdot Si \qquad [ Math . 4 ]$$

### Other Embodiments

The present disclosure is not limited to the above-described embodiments. Various modifications can be made without departing from the scope of the present disclosure.

For example, the unloading line 96 may double as a center bypass line that passes through all the control valves 82. The hydraulic circuit 8, which includes the axial piston pump 1A, is not limited to a hydraulic circuit of a construction machine, but may be a hydraulic circuit of a different type of machine. In this case, the number of hydraulic actuators 83 may be one.

Further, the determination as to whether or not there is an abnormality in the hydraulic rotating equipment 1, the determination being performed by the processing circuitry 72, need not be performed during the idling operation of the engine 10 after the axial piston pump 1A, which is the hydraulic rotating equipment 1, is incorporated in a construction machine. For example, in a production factory of the axial piston pump 1A, the drain pressure of the axial piston pump 1A may be measured in a state where the delivery pressure of the axial piston pump 1A is kept constant, and based on a pressure waveform of the measured drain pressure, the processing circuitry 72 may determine whether or not there is an abnormality in the hydraulic rotating equipment 1.

Alternatively, the determination as to whether or not there is an abnormality in the hydraulic rotating equipment 1, the determination being performed by the processing circuitry 72, may be performed during an operation of any of the hydraulic actuators 83. In this case, the processing circuitry 72 may store, as a pressure waveform, the drain pressure that is measured by the sensor 71 while the axial piston pump 1A is supplying the hydraulic liquid to at least one of the hydraulic actuators 83, and performs frequency analysis on the stored pressure waveform. According to this configuration, whether or not there is an abnormality in the hydraulic rotating equipment 1 can be determined when the delivery pressure of the axial piston pump 1A is high, which makes it possible to improve the abnormality detection accuracy. Consequently, reliability is improved. In addition, there is no loss of time.

In a case where the hydraulic rotating equipment 1 is an axial piston motor, by measuring a drain pressure of the axial piston motor in a state where an inflow pressure to the axial piston motor is kept constant, whether or not there is an abnormality in the axial piston motor can be determined by the same method as the one described in the above embodiment.

### Summary

A first aspect of the present disclosure provides, as a first mode, a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a pressure amplitude of a rotational Mth-degree component in the frequency spectrum, the rotational Mth-degree component being M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the pressure amplitude of the rotational Mth-degree component is greater than the predetermined percentage of the pressure amplitude of the rotational first-degree component, determines that there is an abnormality in the hydraulic rotating equipment.

According to the above configuration, the pressure amplitude of the rotational Mth-degree component is compared with the predetermined percentage of the pressure amplitude of the rotational first-degree component, and thereby whether or not there is an abnormality in the hydraulic rotating equipment is determined. In this manner, an abnormality in the hydraulic rotating equipment can be detected without use of a threshold. In addition, with the above-described determination method, an abnormality in the hydraulic rotating equipment can be detected accurately.

A second aspect of the present disclosure provides, as a second mode, a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a sum of pressure amplitudes of respective at least two rotational degree components selected from among rotational second-degree to Mth-degree components in the frequency spectrum, the rotational second-degree to Mth-degree components being two times to M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

According to the above configuration, the sum of the pressure amplitudes of the at least two rotational degree components selected from among the rotational second-degree component to the rotational Mth-degree component is compared with the predetermined percentage of the pressure amplitude of the rotational first-degree component, and thereby whether or not there is an abnormality in the hydraulic rotating equipment is determined. In this manner, an abnormality in the hydraulic rotating equipment can be detected without use of a threshold. In addition, with the above-described determination method, an abnormality in the hydraulic rotating equipment can be detected accurately.

As a third mode, in the second mode, the processing circuitry may, when determining the sum of the pressure amplitudes of the selected at least two rotational degree components, multiply each of the pressure amplitudes of the selected at least two rotational degree components by a coefficient. According to this configuration, detection accuracy can be improved by weighting using the coefficient.

As a fourth mode, in the second or third mode, for example, the selected at least two rotational degree components may be the rotational second-degree component and the rotational Mth-degree component.

As a fifth mode, in any one of the second to fourth modes, the hydraulic rotating equipment may include an axial piston pump that is driven by an engine with L cylinders (where L is an even number), and the selected at least two rotational degree components may exclude a rotational (L/2)th-degree component. According to this configuration, when determining the sum of the pressure amplitudes of the rotational degree components, the pressure amplitude of the rotational (L/2)th-degree component is excluded. Accordingly, pulsation of the drain pressure due to the engine can be ignored.

A third aspect of the present disclosure provides, as a sixth mode, a system for detecting an abnormality in hydraulic rotating equipment of an axial piston type, the hydraulic rotating equipment including M pistons, the system including: a sensor that measures a drain pressure of the hydraulic rotating equipment; and processing circuitry that performs frequency analysis on a pressure waveform that is a result of measurement by the sensor to generate a frequency spectrum, and if a sum of pressure amplitudes of respective at least two rotational degree components selected from among rotational Mth-degree to (2M)th-degree components in the frequency spectrum, the rotational Mth-degree to (2M)th-degree components being M times to (2M) times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

According to the above configuration, the sum of the pressure amplitudes of the at least two rotational degree components selected from among the rotational Mth-degree component to the rotational (2M)th-degree component is compared with the predetermined percentage of the pressure amplitude of the rotational first-degree component, and thereby whether or not there is an abnormality in the hydraulic rotating equipment is determined. In this manner, an abnormality in the hydraulic rotating equipment can be detected without use of a threshold. In addition, with the above-described determination method, an abnormality in the hydraulic rotating equipment can be detected accurately.

As a seventh mode, in the sixth mode, the processing circuitry may, when determining the sum of the pressure amplitudes of the selected at least two rotational degree components, multiply each of the pressure amplitudes of the selected at least two rotational degree components by a coefficient. According to this configuration, detection accuracy can be improved by weighting using the coefficient.

As an eighth mode, in the sixth or seventh mode, for example, the selected at least two rotational degree components may be the rotational Mth-degree component and the rotational (2M)th-degree component.

As a ninth mode, in any one of the first to eighth modes, the hydraulic rotating equipment may include an axial piston pump that is driven by an engine and that forms a hydraulic circuit of a construction machine together with hydraulic actuators, and the processing circuitry may store, as the pressure waveform, the drain pressure that is measured by the sensor while the axial piston pump is supplying a hydraulic liquid to at least one of the hydraulic actuators, and perform the frequency analysis on the stored pressure waveform. According to this configuration, whether or not there is an abnormality in the hydraulic rotating equipment can be determined when the delivery pressure of the axial piston pump is high, which makes it possible to improve the abnormality detection accuracy. Consequently, reliability is improved. In addition, there is no loss of time.

As a tenth mode, in any one of the first to eighth modes, the hydraulic rotating equipment may include an axial piston pump that is driven by an engine and that forms a hydraulic circuit of a construction machine together with hydraulic actuators. The engine may transition to idling operation when none of the hydraulic actuators is in action. During the idling operation, in a state where a delivery pressure of the axial piston pump is kept to a predetermined value, the processing circuitry may store, as the pressure waveform, the drain pressure that is measured by the sensor, and perform the frequency analysis on the stored pressure waveform. According to this configuration, each time the idling operation is performed, the determination as to whether or not there is an abnormality can be performed automatically, and thus there is no loss of time. Furthermore, it is not necessary to require an operator of the construction machine to perform an onerous operation, such as pressing a drain pressure measurement start button.

What is claimed is:

1. A system for detecting an abnormality in hydraulic rotating equipment of an axial piston type, the hydraulic rotating equipment including M pistons, the system comprising:
a sensor that measures a drain pressure of the hydraulic rotating equipment; and
processing circuitry that performs frequency analysis on a pressure waveform that is a result of measurement by the sensor to generate a frequency spectrum, and if a pressure amplitude of a rotational Mth-degree component in the frequency spectrum, the rotational Mth-degree component being M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the pressure amplitude of the rotational Mth-degree component is greater than the predetermined percentage of the pressure amplitude of the rotational first-degree component, determines that there is an abnormality in the hydraulic rotating equipment.

2. A system for detecting an abnormality in hydraulic rotating equipment of an axial piston type, the hydraulic rotating equipment including M pistons, the system comprising:
a sensor that measures a drain pressure of the hydraulic rotating equipment; and
processing circuitry that performs frequency analysis on a pressure waveform that is a result of measurement by the sensor to generate a frequency spectrum, and if a sum of pressure amplitudes of respective at least two rotational degree components selected from among rotational second-degree to Mth-degree components in the frequency spectrum, the rotational second-degree to Mth-degree components being two times to M times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

3. The system according to claim 2, wherein
the processing circuitry, when determining the sum of the pressure amplitudes of the selected at least two rotational degree components, multiplies each of the pressure amplitudes of the selected at least two rotational degree components by a coefficient.

4. The system according to claim 2, wherein
the selected at least two rotational degree components are the rotational second-degree component and the rotational Mth-degree component.

5. The system according to claim 2, wherein
the hydraulic rotating equipment includes an axial piston pump that is driven by an engine with L cylinders (where L is an even number), and
the selected at least two rotational degree components exclude a rotational (L/2)th-degree component.

6. A system for detecting an abnormality in hydraulic rotating equipment of an axial piston type, the hydraulic rotating equipment including M pistons, the system comprising:
a sensor that measures a drain pressure of the hydraulic rotating equipment; and
processing circuitry that performs frequency analysis on a pressure waveform that is a result of measurement by the sensor to generate a frequency spectrum, and if a sum of pressure amplitudes of respective at least two rotational degree components selected from among rotational Mth-degree to (2M)th-degree components in the frequency spectrum, the rotational Mth-degree to (2M)th-degree components being M times to (2M) times as great as a rotational frequency, is less than a predetermined percentage of a pressure amplitude of a rotational first-degree component in the frequency spectrum, the rotational first-degree component being one time as great as the rotational frequency, determines that the hydraulic rotating equipment is in a normal condition, whereas if the sum is greater than the predetermined percentage of the pressure amplitude of the rotational first-degree component, determines that there is an abnormality in the hydraulic rotating equipment.

7. The system according to claim 6, wherein
the processing circuitry, when determining the sum of the pressure amplitudes of the selected at least two rotational degree components, multiplies each of the pressure amplitudes of the selected at least two rotational degree components by a coefficient.

8. The system according to claim 6, wherein
the selected at least two rotational degree components are the rotational Mth-degree component and the rotational (2M)th-degree component.

9. The system according to claim 1, wherein
the hydraulic rotating equipment includes an axial piston pump that is driven by an engine and that forms a hydraulic circuit of a construction machine together with hydraulic actuators, and
the processing circuitry stores, as the pressure waveform, the drain pressure that is measured by the sensor while the axial piston pump is supplying a hydraulic liquid to at least one of the hydraulic actuators, and performs the frequency analysis on the stored pressure waveform.

10. The system according to claim 2, wherein
the hydraulic rotating equipment includes an axial piston pump that is driven by an engine and that forms a hydraulic circuit of a construction machine together with hydraulic actuators, and
the processing circuitry stores, as the pressure waveform, the drain pressure that is measured by the sensor while the axial piston pump is supplying a hydraulic liquid to at least one of the hydraulic actuators, and performs the frequency analysis on the stored pressure waveform.

11. The system according to claim 6, wherein
the hydraulic rotating equipment includes an axial piston pump that is driven by an engine and that forms a hydraulic circuit of a construction machine together with hydraulic actuators, and
the processing circuitry stores, as the pressure waveform, the drain pressure that is measured by the sensor while the axial piston pump is supplying a hydraulic liquid to at least one of the hydraulic actuators, and performs the frequency analysis on the stored pressure waveform.

12. The system according to claim 1, wherein
the hydraulic rotating equipment includes an axial piston pump that is driven by an engine and that forms a hydraulic circuit of a construction machine together with hydraulic actuators,
the engine transitions to idling operation when none of the hydraulic actuators is in action, and
during the idling operation, in a state where a delivery pressure of the axial piston pump is kept to a predetermined value, the processing circuitry stores, as the pressure waveform, the drain pressure that is measured by the sensor, and performs the frequency analysis on the stored pressure waveform.

13. The system according to claim 2, wherein
the hydraulic rotating equipment includes an axial piston pump that is driven by an engine and that forms a hydraulic circuit of a construction machine together with hydraulic actuators,
the engine transitions to idling operation when none of the hydraulic actuators is in action, and
during the idling operation, in a state where a delivery pressure of the axial piston pump is kept to a predetermined value, the processing circuitry stores, as the pressure waveform, the drain pressure that is measured by the sensor, and performs the frequency analysis on the stored pressure waveform.

14. The system according to claim 6, wherein
the hydraulic rotating equipment includes an axial piston pump that is driven by an engine and that forms a hydraulic circuit of a construction machine together with hydraulic actuators,
the engine transitions to idling operation when none of the hydraulic actuators is in action, and
during the idling operation, in a state where a delivery pressure of the axial piston pump is kept to a predetermined value, the processing circuitry stores, as the pressure waveform, the drain pressure that is measured by the sensor, and performs the frequency analysis on the stored pressure waveform.
